(19) United States
(12) Patent Application Publication
(10) Pub. No.: US 2025/0211635 A1
(43) Pub. Date: Jun. 26, 2025

(54) PEER-TO-PEER COMMUNICATION IN WIRELESS NETWORKS

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Vishnu Vardhan Ratnam, Plano, TX (US); Yue Qi, Plano, TX (US)

(21) Appl. No.: 18/974,688

(22) Filed: Dec. 9, 2024

Related U.S. Application Data
(60) Provisional application No. 63/614,839, filed on Dec. 26, 2023.

(51) Int. Cl. H04L 67/104; H04W 72/50; H04W 72/543

(52) U.S. Cl. CPC H04L 67/104; H04W 72/535; H04W 72/543

(57) ABSTRACT

A station (STA) in a wireless network transmits, to an access point (AP), a stream classification service (SCS) request for itself and on behalf of another peer STA. The STA receives, from the AP, a first SCS response for the SCS request for STA and a second SCS response for the SCS request for peer STA. STA or peer STA may receive a trigger frame granting a transmission opportunity (TXOP) via the P2P direct link established between the STA and the peer STA, if the AP accepts the SCS request associated with that STA.

### CROSS REFERENCE TO RELATED APPLICATION

This application claims benefit of U.S. Provisional Application No. 63/614,839, entitled “Peer-to-Peer SCS Negotiation for Next Generation WLAN Systems,” filed on Dec. 26, 2023, in the United States Patent and Trademark Office, the entire contents of which are hereby incorporated by reference.

### TECHNICAL FIELD

This disclosure relates generally to a wireless communication system, and more particularly to, for example, but not limited to, peer-to-peer (P2P) communication in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

An aspect of the disclosure provides first station (STA) in a wireless network. The first station comprises a memory and a processor coupled to the memory. The processor is configured to cause transmitting, to an access point (AP), a request frame that requests a resource from the AP for a peer-to-peer (P2P) transmission performed by a second STA. A P2P link is established between the first STA and the second STA.

In some embodiments, the request frame includes Quality of Service (QOS) requirement for the second STA.

In some embodiments, the request frame further requests a resource from the AP for a P2P transmission performed by the first STA.

In some embodiments, the request frame requests a resource from the AP for P2P transmissions performed by a plurality of STAs.

In some embodiments, the request frame includes QoS requirement for the first STA.

In some embodiments, the request frame further comprises a first element associated with QoS requirement for the first STA and a second element associated with QoS requirement for the second STA.

In some embodiments, the processor is further configured to cause receiving, from the AP, a trigger frame that allocates a transmission opportunity (TXOP). The processor is further configured to cause performing a P2P communication with a peer STA during the allocated TXOP.

In some embodiments, the trigger frame is received during a target wake time (TWT) service period (SP) established between the first STA and the AP. The processor is configured to cause performing the P2P communication with the peer STA during the TWT SP.

An aspect of the disclosure provides an access port (AP) in a wireless network. The AP comprises a memory and a processor coupled to the memory. The memory is configured to cause receiving, from a first station (STA), a request frame that requests a resource from the AP for a peer-to-peer (P2P) transmission performed by a second STA. A P2P link is established between the first STA and the second STA. The processor is configured to cause transmitting to the second STA, a first trigger frame that allocates a transmission opportunity (TXOP) to the second STA in response to the request frame.

In some embodiments, the request frame includes Quality of Service (QOS) requirement for the second STA.

In some embodiments, the request frame further requests a resource from the AP for a P2P transmission performed by the first STA.

In some embodiments, the request frame requests a resource from the AP for P2P transmissions performed by a plurality of STAs.

In some embodiments, the request frame includes QOS requirement for the first STA.

In some embodiments, the request frame further comprises a first element associated with QoS requirement for the first STA and a second element associated with QoS requirement for the second STA.

In some embodiments, the processor is further configured to cause transmitting, to the first STA, a second trigger frame that allocates a transmission opportunity (TXOP) in response to the request frame.

In some embodiments, the first trigger frame is transmitted to the second STA during a first target wake time (TWT) service period (SP). The second trigger frame is transmitted to the first STA during a second TWT SP.

An aspect of the disclosure provides a method performed by a station (STA) in a wireless network. The method comprises transmitting, to an access point (AP), a request frame that requests a resource from the AP for a peer-to-peer (P2P) transmission performed by a second STA. A P2P link is established between the first STA and the second STA.

In some embodiments, the request frame includes Quality of Service (QOS) requirement for the second STA.

In some embodiments, the request frame requests a resource from the AP for P2P transmissions performed by a plurality of STAs.

In some embodiments, the method further comprises receiving, from the AP, a trigger frame that allocates a transmission opportunity (TXOP). The method further comprises performing a P2P communication with a peer STA during the allocated TXOP.

In some embodiments, the trigger frame is received during a target wake time (TWT) service period established between the first STA and the AP. The method further comprises performing the P2P communication with the peer STA during the TWT SP.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example network in accordance with an embodiment.

FIG. 5 shows an example of the need for timely delivery of latency-sensitive P2P traffic.

FIG. 6 shows an example of P2P communication in accordance with an embodiment.

FIG. 7 shows an example of a QoS expectation establishment for a P2P Direct link in accordance with an embodiment.

FIG. 8 shows an example of SCS negotiations for multiple STAs in accordance with an embodiment.

FIG. 9 shows a joint SCS negotiation for multiple STAs.

FIG. 10 shows an example scenario of transmissions within separate SPs.

FIG. 11 shows an example scenario of transmissions within a common SP.

FIG. 12 shows an example scenario of transmissions during a common SP served using a same won TXOP.

FIG. 13 shows an example scenario of transmissions during a common SP served using separate won TXOPs.

FIG. 14 shows an example scenario of transmissions during separate SPs served using a separate won TXOP.

FIG. 15 shows a possible format of the Control Info field of the QoS Characteristics element.

FIG. 16 shows a possible format for the QoS Characteristics element including P2P User Information subfield.

FIG. 17 shows a possible format for the P2P User Information field in the QoS Characteristics element.

FIG. 18 shows a possible format of the P2P User Info subfield.

FIG. 19 shows a STA-side procedure for a first STA requesting SCS negotiation on behalf of a second STA's P2P traffic over a P2P direct link.

FIG. 20 shows an AP-side procedure for an AP responding to joint SCS negotiation for P2P transmission over P2P direct link.

FIG. 21 shows a flowchart of the operation of a STA in accordance with an embodiment of this invention.

FIG. 22 shows a flowchart of the operation of an AP in accordance with an embodiment of this invention.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The present disclosure relates to a wireless communication system, and more particularly, to a Wireless Local Area Network (WLAN) technology. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

Before undertaking the detailed description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Figures discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

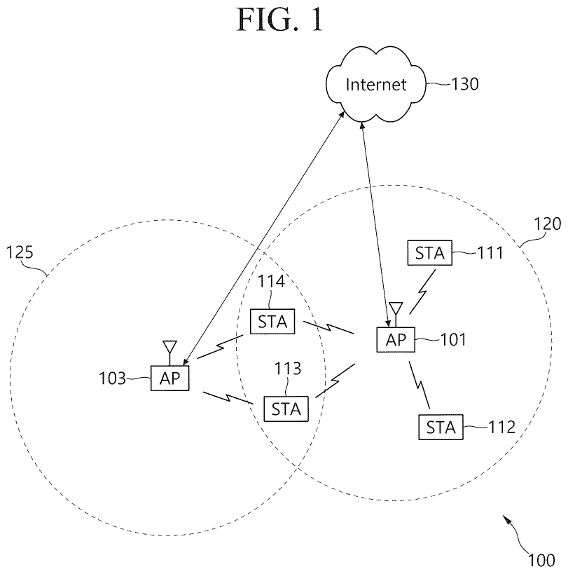

FIG. 1 shows an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

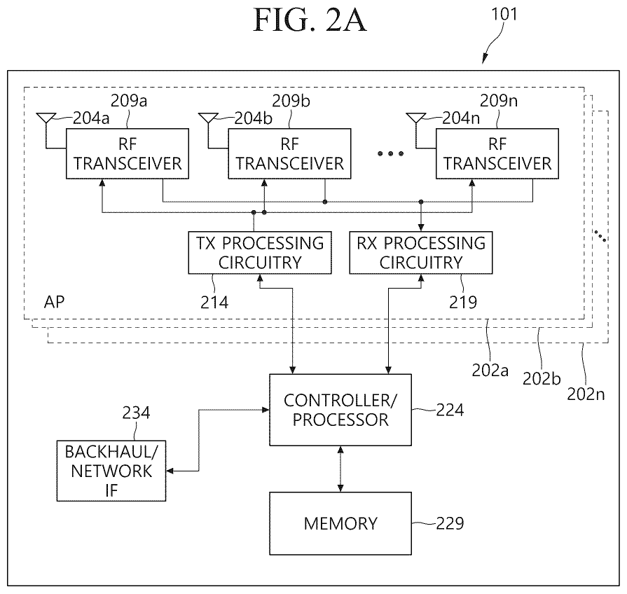

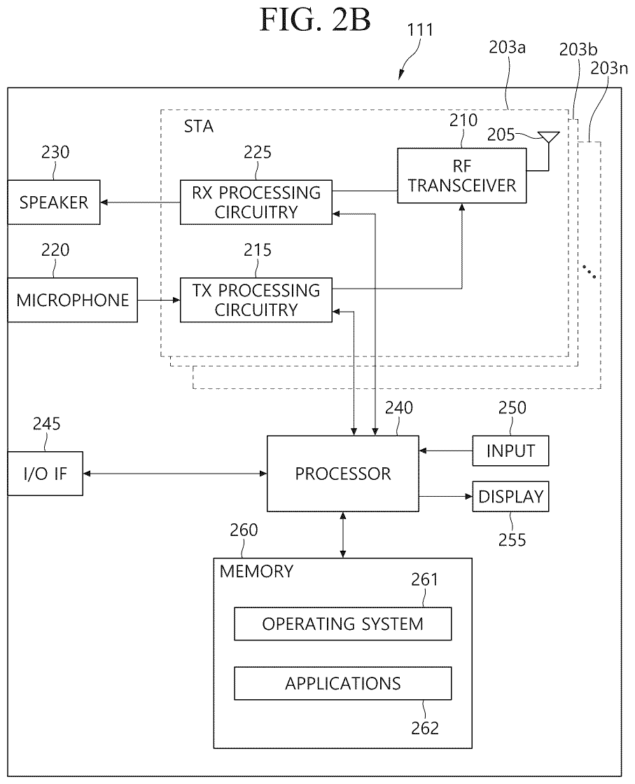

FIG. 2A shows an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As shown in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

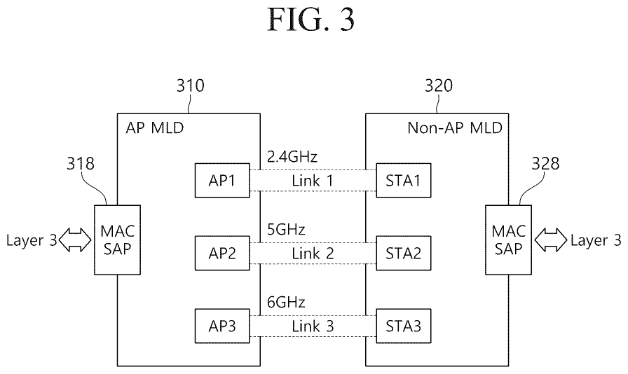

FIGS. 2 and 3 illustrate example electronic devices in accordance with an embodiment of this disclosure. In particular, FIG. 2 shows an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions.

For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A shows one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B shows an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As shown in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of channel sounding procedures in WLANs. In some embodiments, the controller/processor 240 includes at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B shows the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D3.0, “Wireless LAN Medium Access Control (MAC) and Physical Layer (PHY) Specifications.”

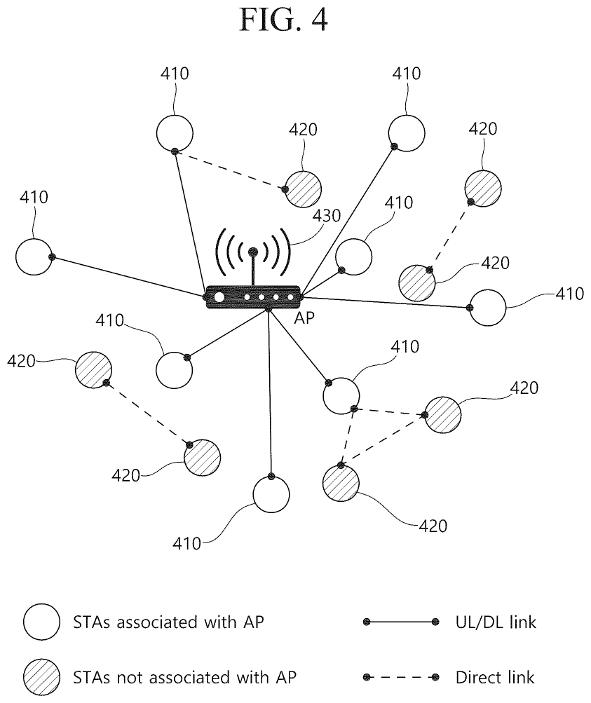

FIG. 4 shows an example network in accordance with an embodiment. The network depicted in FIG. 4 is for explanatory and illustration purposes. FIG. 4 does not limit the scope of this disclosure to any particular implementation.

In FIG. 4, a plurality of STAs 410 may be non-AP STAs associated with AP 430, and a plurality of STAs 420 may be non-AP STAs which are not associated with AP 430. Additionally, solid lines between STAs represent uplink or downlink with AP 430, while the dashed lines between STAs represent a direct link between STAs.

Next generation WLAN system needs to provide improved support for low-latency applications. Today, it is common to observe numerous devices operating on the same network as shown in FIG. 4. Many of these devices may have a tolerance for latency, but still compete with the devices running low-latency applications for the same time and frequency resources. In some cases, the AP 430 as a network controller may not have enough control over the unregulated or unmanaged traffic that contends with the low-latency traffic within the infrastructure basic service set (BSS). In some embodiments, the infrastructure BSS is a basic service set that includes an AP 430 and one or more non-AP STAs 410, while the independent BSS is a basic service set where non-AP STAs 420 communicate with each other without the need for a centralized AP. Some of the unregulated or unmanaged traffic that interferes with the latency-sensitive traffic in the BSS of the AP may originate from uplink, downlink, or direct link communications within the infrastructure BSS that the AP manages. Another source of the interference may be transmission from the neighboring infrastructure OBSS (Overlapping Basic Service Set), while others may come from neighboring independent BSS or P2P networks. Therefore, the next generation WLAN system needs mechanisms to more effectively handle unmanaged traffic while prioritizing low-latency traffic in the network.

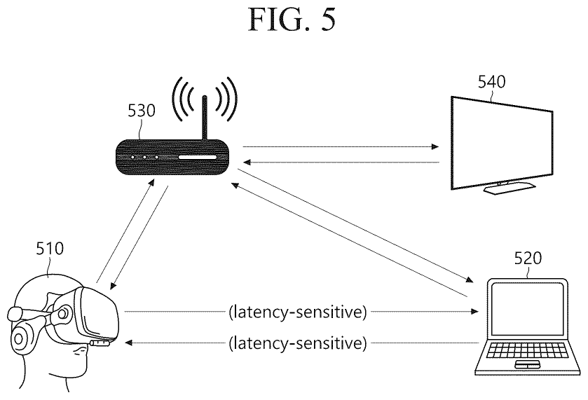

FIG. 5 shows an example scenario illustrating a need for timely delivery of latency-sensitive P2P traffic in accordance with an embodiment. The scenario depicted in FIG. 5 is for explanatory and illustration purpose. FIG. 5 does not limit the scope of this disclosure to any particular implementation.

In FIG. 5, the example scenario includes a head-mounted device (HMD) 510, a laptop 520, and a television 540 and an AP 530. In this example, the HMD and the laptop are STAs (non-AP STAs). The HMD 510, the laptop 520 and the television 540 are associated with the AP 530. Additionally, the HMD 510 and the laptop 520 have latency sensitive P2P traffic to communicate with each other. The television 540 in this example scenario may also refer to other STAs which the AP 530 may be delivering traffic to. The television 540 may also communicate, with AP 530, in downlink and uplink traffic resulting in a heavily loaded environment.

The laptop 520 may not be able to deliver its P2P traffic in a timely manner in a heavily loaded environment as shown in FIG. 5. If the STA (HMD 510 or laptop 520) has latency-sensitive traffic for another peer STA, the latency-sensitive traffic needs to be delivered within a given delay bound. When the STA (HMD 510 OR laptop 520) is unable to access the channel for P2P communication, it may disrupt latency sensitive applications.

P2P communication has become very important for today's WLAN systems. In a heavily loaded environment, ensuring the Quality of service (QOS) requirement for P2P communication is critical for the timely delivery of low-latency P2P traffic. There may be two types of P2P communication. The first type is P2P communication through an AP. The second type is P2P communication over a P2P direct link established between two peer STAs.

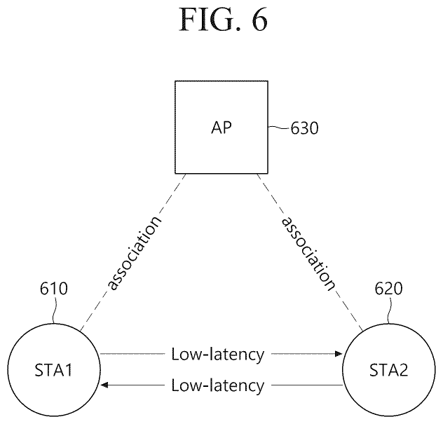

FIG. 6 shows an example of P2P communication in accordance with an embodiment. The example depicted in FIG. 6 is for explanatory and illustration purposes. FIG. 6 does not limit the scope of this disclosure to any particular implementation. FIG. 6 shows an example of the first type of P2P communication.

In FIG. 6, STA1 610 and STA2 620 may be in P2P communication through a P2P direct link. STA1 and STA2's transmitted traffic may have low-latency. AP 630 may be associated with both the STA1 610 and the STA2 620. Either STA1 610 or STA2 620 may transmit frames to AP 630. Subsequently, AP 630 may transmit or relay those frames to the other STA.

In the second type of P2P communication, a peer STA1 and a peer STA2 transmit traffic over the P2P direct link established between the two peer STAs. Peer STA1 and peer STA2 need to be associated with the same AP, if the P2P direct link is a tunneled direct-link setup (TDLS) link. Peer STA1 and peer STA2 may not need to be associated with any AP if the P2P direct link is Wi-Fi Direct link or Wi-Fi Aware link. Peer STA1 and peer STA2 may still be associated with the same AP or different AP, if the P2P direct link is WiFi Direct link or Wi-Fi Aware link.

In heavily loaded (high traffic) WLAN systems, it would be beneficial if the AP could assist the peer STAs in delivering their P2P traffic over a direct link in a timely manner. However, in the conventional WLAN, there is no mechanism that allows either STA to efficiently request AP's resources for other peer STA(s) for transmission of traffic over the P2P direct link.

In some embodiments, a first STA may initiate a QoS request by transmitting a request frame to its associated AP. The first STA may establish a QoS expectation on behalf of a second STA with the request frame. The QoS expectation may be associated with traffic delivery for the second STA over a P2P direct link. The AP may infer the QoS expectation from a set of parameters in the request frame. The set of parameters in the request frame may indicate the necessary QoS requirement for the second STA for which the QoS request is made to the AP. In an embodiment, the QoS request may use an existing QoS frame, for example and without limitation, by modifying the stream classification service (SCS) request-response procedure. In another embodiment, the QOS request may use a new frame that includes QoS parameters for the STA for which the QoS request is made.

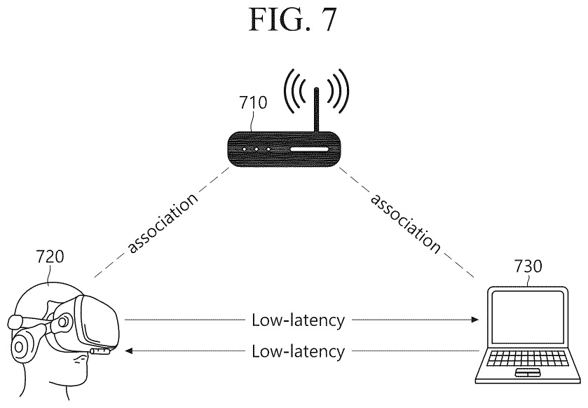

FIG. 7 shows an example of establishing a QoS expectation for a P2P Direct link in accordance with an embodiment.

Referring to FIG. 7, a HMD 720 and a laptop 730 are associated with an AP 710. Additionally, the HMD 720 and the laptop 730 communicate directly over a P2P direct link established between them. The HMD 720 and the laptop 730 may have low-latency traffic.

In FIG. 7, the laptop 730 may transmit a QoS request to AP 710 on behalf of the HMD 720 for the P2P direct link between the laptop 730 and the HMD 720. In an embodiment, the laptop 730 may transmit a SCS request frame to AP 710. The SCS request frame may indicate that the SCS request frame is sent on behalf of the HMD 720, for example and without limitation, by including an identifier to identify the HMD 720. The SCS request frame may also indicate that the SCS request is for the P2P link of HMD 720. In an embodiment, the SCS request frame may set the “Direction” field in the QoS Characteristics element in the SCS frame to 1 to indicate that the QoS request is for P2P direct link communication. In response, AP 710 may then transmit a SCS response frame in which AP 710 accepts, rejects or suggests some alternative parameters for the SCS request frame. The SCS response frame may also indicate that the response is for the HMD 720.

In some embodiments, a first STA may transmit a request frame, for example a SCS request frame, to its associated AP. The first STA may establish a QoS expectation on behalf of a second STA's P2P direct link with the request frame. The first STA may also establish a QoS expectation for the first STA's P2P direct link with the request frame. The request frame may be, for example and without limitation, a joint QOS request frame for the P2P direct link. The corresponding response frame may be a joint QoS response frame for the P2P direct link. In one embodiment, a request and response frame may be referred to as a joint QoS request for P2P direct link and a joint SCS response for P2P direct link, respectively, when SCS procedure is used to set up a QoS expectation. In some embodiments, a joint QoS request may also comprise a QoS request on behalf of a group of STAs' P2P direct link comprising two or more STAs' P2P direct links. Accordingly, a joint QoS response may also comprise responses to QoS requests for a group of STAs' P2P direct link.

In some embodiments, a group of STAs may use a similar procedure. In an embodiment, a first STA may transmit, to an AP, a request frame indicating a QoS requirement for P2P direct links of a group of non-AP STAs. A joint QoS request frame or joint SCS request frame may comprise a QoS request or a SCS request for two or more STAs. Accordingly, a joint QoS response frame or a joint SCS response frame from an AP may comprise QoS responses or SCS responses for a group of STAs. In some embodiments, a first STA may transmit an SCS request to an associated AP on behalf of a second STA's P2P direct link. In an embodiment, a first STA may transmit a SCS request frame to an associated AP. The SCS request frame may include an indicator indicating that the SCS request frame may be for a second non-AP STA. The indicator may also indicate that the QoS request or SCS request may be for a second non-AP STA's P2P direct link. The second non-AP STA may also be associated with the same AP. In some embodiments, the second STA may not be associated with the AP. In some embodiments, both the first STA and the second STA are associated with the AP.

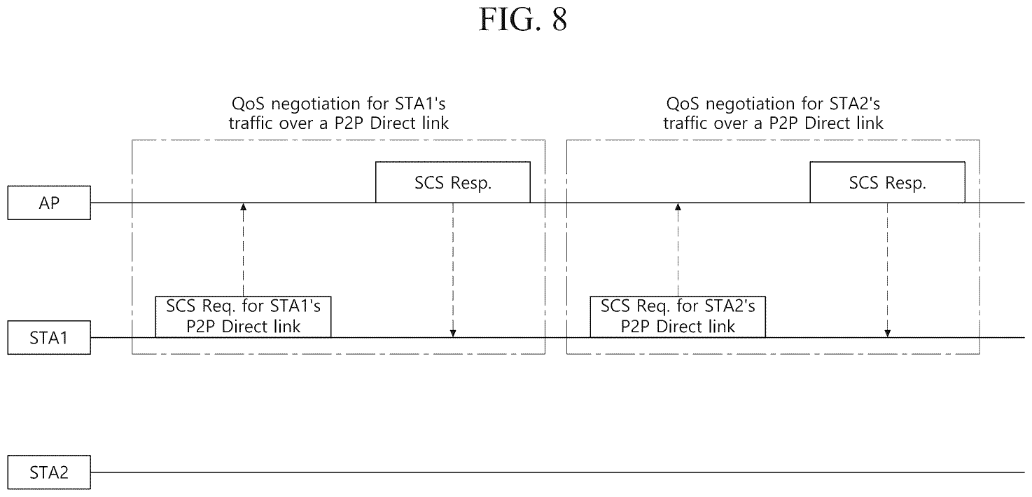

FIG. 8 shows an example of SCS negotiations for multiple STAs in accordance with an embodiment. The example depicted in FIG. 8 is for explanatory and illustration purposes. FIG. 6 does not limit the scope of this disclosure to any particular implementation.

In FIG. 8, STA1 may be associated with an AP. STA2 may be or may not be associated with AP. STA1 and STA2 may communicate directly over a P2P direct link. STA1 may be a UHR (ultra high reliability) device. Both STA1 and STA2 may have some periodic traffic patterns with specific QoS requirements for their P2P direct link. STA1 and STA2 may lack the resources to fulfill QoS requirements for communication over the P2P direct link. Therefore, STA1 and STA2 may need assistance from AP in fulfilling their QoS requirements for communication over the P2P direct link.

Referring to FIG. 8, STA1 may transmit a first SCS request frame to AP to solicit resources from AP to fulfill the QOS requirements for STA1's P2P direct link. The QoS requirements may be specified by one or more parameters in the first SCS request frame. In an embodiment, a QoS Characteristics element included in the first SCS request frame may comprise the one or more parameters that identify the QoS requirements for STA1. More specifically, the Direction subfield of the QoS Characteristics element may be set to “Direct Link” to indicate that the QoS resources are requested for a P2P direct link. AP then may transmit a first SCS response frame to STA1 in response to the first SCS request frame. The first SCS response frame may indicate acceptance, rejection, or suggestion of alternative SCS parameters for STA1. The first SCS response frame may comprise an indicator indicating the reasoning for the AP's decision if the first SCS response has any response other than acceptance. In some embodiments, the indicator may be in the form of reason codes.

Subsequently, STA1 may transmit a second SCS request frame to AP to solicit resources from AP to fulfill the QoS requirements for STA2's P2P direct link on behalf of STA2. The second SCS request may comprise QOS Characteristics element(s) that may comprise parameters that specify the QoS requirement(s) for STA2. In response, AP may transmit a second SCS response frame to STA1. The second SCS response frame may indicate whether AP accepts, rejects, or suggests some alternative parameter for the second SCS request frame.

In some embodiments, AP may transmit the SCS response to STA2 in response to the second SCS request received from STA1 on behalf of STA2 for STA2's P2P direct link.

In some embodiments, STA1 may transmit a joint SCS request to AP, where the joint SCS request may comprise SCS requests for STA1's P2P direct link as well as a STA2's P2P direct link. AP may transmit a joint SCS response to STA1 in response to the joint SCS request upon receiving the joint SCS request from STA1.

In some embodiments, AP may transmit a SCS response to STA2 in response to the joint SCS request received from STA1 for both STAs' P2P direct link.

The joint SCS response may comprise decisions on separate SCS requests or joint decisions on SCS requests from both the first STA and the second STA. In an embodiment, the SCS responses may comprise the following sample decisions: accept both SCS requests; reject both SCS requests; accept the SCS request of the first STA but reject the SCS request of the second STA; reject the SCS request of the first STA but accept the SCS request for the second STA; suggest alternative parameters for one of the SCS requests and accept/reject the other SCS requests; or suggest alternative parameters for both of the STAs.

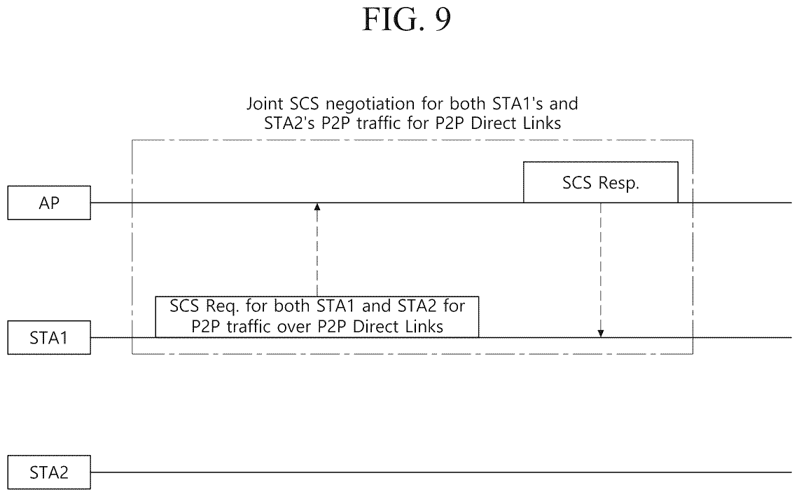

FIG. 9 shows an example of a joint SCS negotiation for multiple STAs in accordance with an embodiment.

In FIG. 9, STA1 and STA2 are in P2P communication over a P2P direct link. The AP is associated with STA1. STA1 performs QoS negotiation for P2P traffic over P2P direct links with an AP.

In FIG. 9, STA1 may transmit a joint SCS request to the AP for P2P direct link. The joint SCS request comprises an SCS request for STA1's P2P direct link as well as an SCS request for STA2's P2P direct link.

In some embodiments, the joint SCS request may be transmitted in the form of an SCS request frame or some other frames that comprise similar information as the SCS request frame. The SCS request frame may comprise two QOS characteristics elements. The first QoS characteristics element may be associated with STA1's P2P communication, while the second QoS characteristics element may be associated with STA2's P2P communication.

In some embodiments, the SCS request frame may comprise a single QoS Characteristics element. The QoS Characteristics element may indicate information about a STA's P2P QOS traffic. The SCS request frame may include an indicator indicating that the QoS Characteristics element is associated with both STA1's P2P QOS traffic and STA2's P2P QOS traffic. In response, AP may transmit a SCS response frame to STA1 indicating the responses to the SCS request received from STA1.

In some embodiments, the AP may transmit the SCS response frame to STA2 indicating the responses to the SCS request frame of the prior embodiment.

In some embodiments, a first STA may transmit a SCS request to an associated AP for a second STA's P2P direct link. AP may transmit a trigger frame to the second STA in response to receiving the SCS request if AP accepts the SCS request. AP may then allocate a transmission opportunity (TXOP) to the second STA. Subsequently, the second STA may transmit its P2P traffic over a P2P direct link using the allocated TXOP. In an embodiment, the trigger frame may be a multi-user (MU)—request to send (RTS) transmissions (TXS) (Mode-2) trigger frame or some variant of a MU-RTS TXS (mode 2) trigger frame.

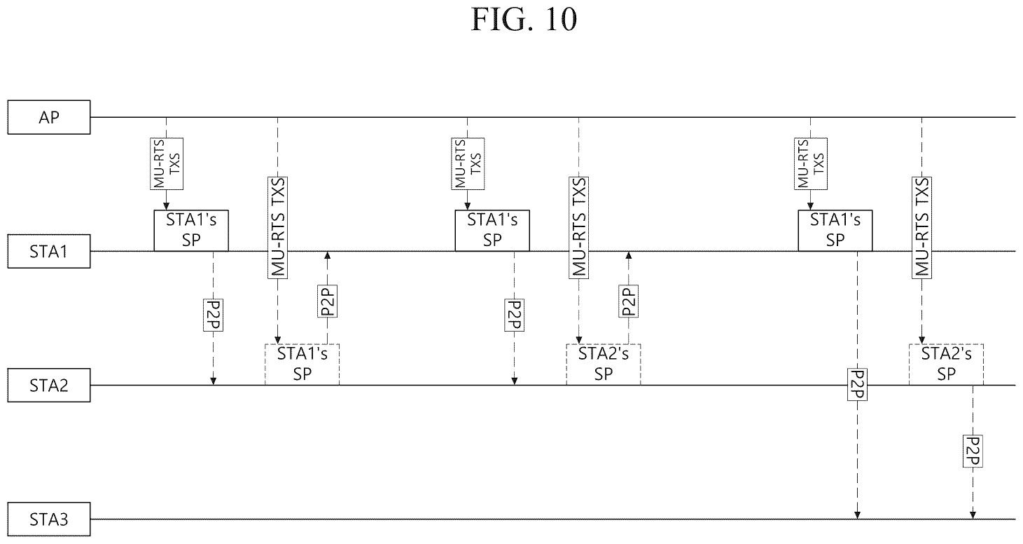

FIG. 10 shows an example scenario of transmissions within separate service periods in accordance with an embodiment.

In FIG. 10, AP is associated with both STA1 and STA2. STA 1 and STA 2 may communicate directly over a P2P direct link. STA 1 and STA 3 may also communicate directly over a P2P link. Similarly, STA 2 and STA 3 may communicate directly over a P2P link. STA 3 may not be associated with AP. Additionally, AP established a first target wake time (TWT) service period (SP) with STA 1, and a second TWT SP with STA 2.

Referring to FIG. 10, an AP may use a separate SP (service period) setup for two STAs for their traffic over P2P direct links. AP may then allocate a TXOP to each of the STAs during their respective SPs. AP may allocate a TXOP by transmitting a trigger frame to a STA. In one embodiment, AP may allocate TXOPs by transmitting MU-RTS TXS trigger frames.

In FIG. 10, it is assumed that AP has already accepted a joint SCS request received from STA1. The joint SCS request may establish a QoS expectation for STA1 and on behalf of STA2. AP may transmit trigger frames to STA1 and STA2 to allocate TXOP. More specifically, AP transmits MU-RTS TXS trigger frame to STA1 during a first TWT SP. The MU-RTS TXS trigger frame may allocate to STA1 a portion of the TXOP obtained by AP. In response, STA1 performs P2P communication with STA2 or STA3 during the allocated TXOP. Similarly, AP transmits MU-RTS TXS trigger frame to STA2 during a second TWT SP. The MU-RTS TXS trigger frame may allocate to STA2 a portion of the TXOP obtained by AP. In response, STA2 performs P2P communication with STA1 or STA3 during the allocated TXOP. The schedule determined by AP specifies the patterns of arrival of the trigger frames. In an embodiment, for example, but not limited to, the joint SCS response may comprise two different QoS Characteristics elements for the two STA's P2P direct links.

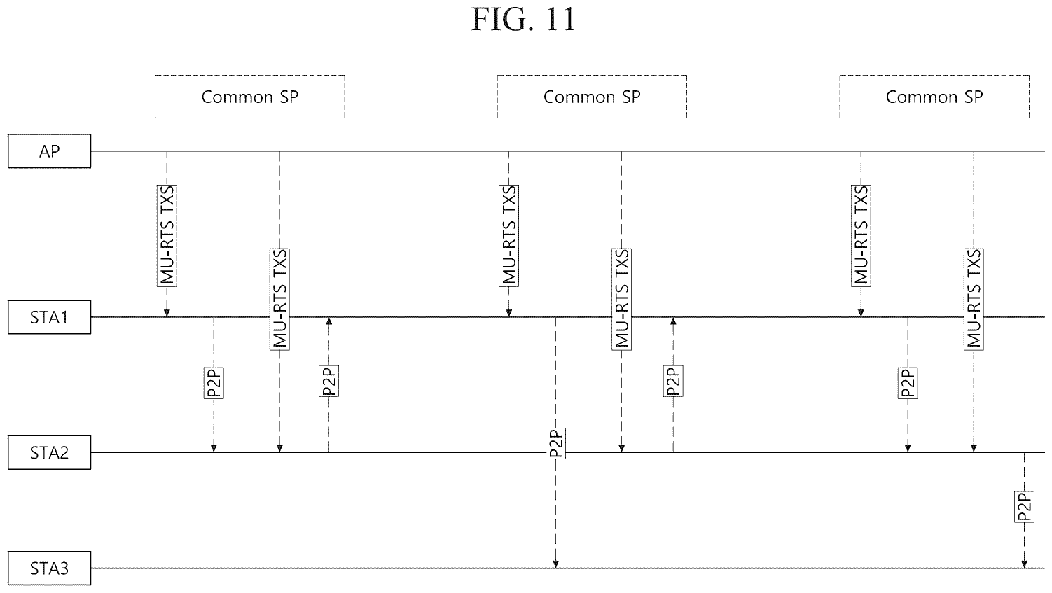

FIG. 11 shows an example scenario of transmissions within a common SP in accordance with an embodiment.

In FIG. 11, AP is associated with both STA1 and STA2. STA 1 and STA 2 may communicate directly over a P2P direct link. STA 1 and STA 3 may also communicate directly over a P2P link. Similarly, STA 2 and STA 3 may communicate directly over a P2P link. STA 3 may not be associated with AP. Additionally, AP established a first common target wake time (TWT) service period (SP).

Referring to FIG. 11, an AP may use a common SP setup for two STAs for their traffic over P2P direct links. AP may then allocate a TXOP to each STA during this common SP.

In FIG. 11, it is assumed that the AP has already accepted a joint SCS request received from STA1. The joint SCS request may establish a QoS expectation for STA1 and on behalf of STA2. AP may transmit trigger frames to STA1 and STA2 to allocate TXOP. More specifically, AP transmits MU-RTS TXS trigger frame to STA1 during a first common TWT SP, Common SP. The MU-RTS TXS trigger frame may allocate to STA1 a portion of the TXOP obtained by AP. In response, STA1 performs P2P communication with STA2 or STA3 during the allocated TXOP. Similarly, AP transmits MU-RTS TXS trigger frame to STA2 during the first common TWT SP, Common SP. The MU-RTS TXS trigger frame may allocate to STA2 a portion of the TXOP obtained by AP. In response, STA2 performs P2P communication with STA1 or STA3 during the allocated TXOP. In an embodiment, a joint SCS response may comprise two different QoS Characteristics elements for the two STA's P2P direct links. The AP may determine a common schedule for traffic for STA1 and STA2 in the joint SCS response. Accordingly, the AP may transmit trigger frames to both STA1 and STA2 during the SP of that common schedule.

In an embodiment, a joint SCS request frame's QOS Characteristics elements' “Direction” subfield may indicate “Direct Link”. Accordingly, the corresponding joint SCS response frame's QoS Characteristics element(s) may indicate “Direct Link”.

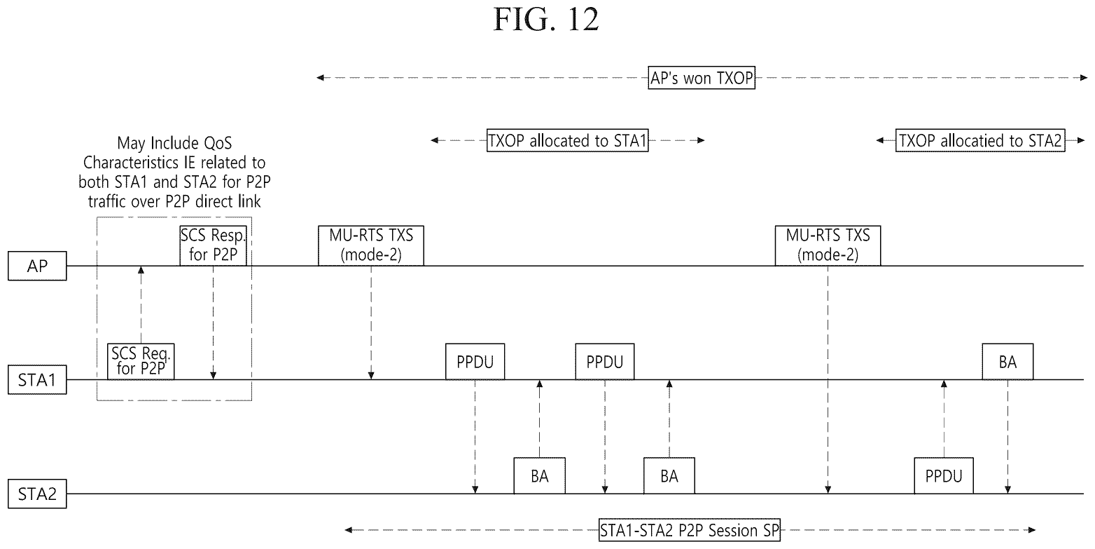

FIG. 12 shows an example scenario of transmissions during a common SP served using a same won TXOP in accordance with an embodiment.

In FIG. 12, STA1 and STA2 may communicate directly over a P2P direct link. AP is not associated with STA1 or STA2.

Referring to FIG. 12, the AP may allocate a same TXOP to serve both STA1 and STA2 for frame exchanges during a common SP for STAs in P2P communication over a P2P direct link.

In FIG. 12, STA1 may perform SCS negotiation by transmitting a joint SCS request to AP for P2P communication over a P2P direct link. In response, AP may transmit a joint SCS response for P2P traffic transmission over a P2P direct link. Subsequently, AP may transmit a trigger frame to STA1 allocating a portion of AP's obtained TXOP to STA1 and a common SP begins. During the time allocated to STA1, STA1 may perform P2P communication with STA2. More specifically, STA1 sends one or more PPDUs to STA2 within the time allocated to STA1. STA2 sends a block acknowledgement (BA) frame in response to PPDUs transmitted from STA1. Similarly, AP may transmit a trigger frame to STA2 allocating a portion of AP's obtained TXOP to STA1 during a common SP. During the time allocated to STA2, STA2 may perform P2P communication with STA1. More specifically, STA2 sends one or more PPDUs to STA1 within the time allocated to STA2. STA1 sends a BA frame in response to PPDUs transmitted from STA1. Subsequently, the common SP then ends. In the above embodiment, AP may serve both STAs using a single TXOP.

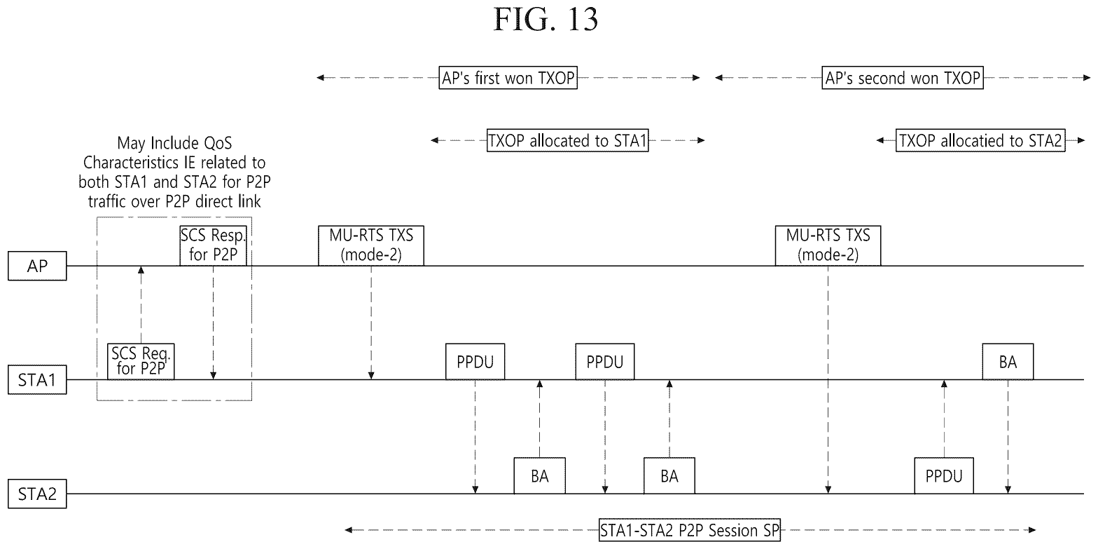

FIG. 13 shows an example scenario of transmissions during a common SP served using separate obtained TXOPs in accordance with an embodiment.

In FIG. 13 STA1 and STA2 may communicate directly over a P2P direct link. AP is not associated with STA1 or STA2.

Referring to FIG. 13, most operations are similar to or the same as operations in FIG. 12 with the exception that AP allocates separate TXOPs to serve STA1 and STA2 for frame exchanges during a common SP for STA1 and STA2 in P2P traffic over a P2P direct link.

In FIG. 13, STA1 performs SCS negotiation as described in FIG. 12. Subsequently, AP allocates its first obtained TXOP to STA1 by transmitting a first trigger frame. STA1 receives the first trigger frame and a common SP begins. In response, STA1 and STA2 engage in similar operations as described in FIG. 12 during the first obtained TXOP. Subsequently, AP allocates its second obtained TXOP to STA2 by transmitting a second trigger frame. In response, STA1 and STA2 engage in similar operations as described in FIG. 12 during the second obtained TXOP. Subsequently, the common SP then ends.

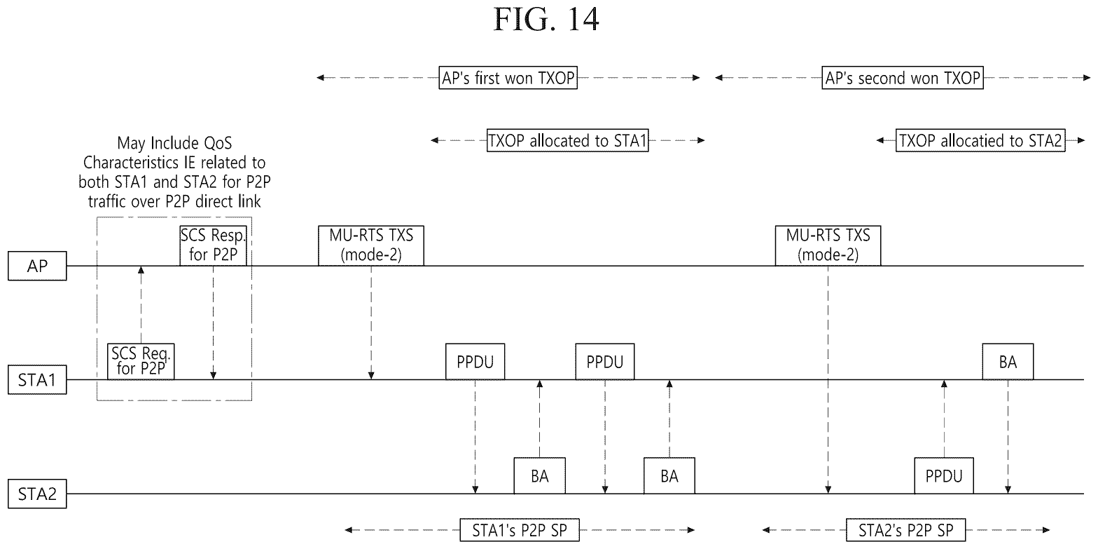

FIG. 14 shows an example scenario of transmissions during separate SPs served using a separate obtained TXOP in accordance with an embodiment.

Referring to FIG. 14, most operations are similar to or the same as operations in FIG. 12 with the exception that AP may allocate separate TXOPs to serve STA1 and STA2 for frame exchanges during separate SPs for STA1 and STA2 in P2P traffic over P2P direct link.

In FIG. 14, STA1 performs SCS negotiation as described in FIG. 12. Subsequently, AP allocates its first obtained TXOP to STA1 by transmitting a first trigger frame and a first SP begins. STA1 receives the first trigger frame. In response, STA1 and STA2 engage in similar operations as described in FIG. 12 during the first obtained TXOP and the first SP ends. Subsequently, AP allocates its second obtained TXOP to STA2 by transmitting a second trigger frame and a second SP begins. Subsequently, AP allocates its second obtained TXOP to STA2 by transmitting a second trigger frame. In response, STA1 and STA2 engage in similar operations as described in FIG. 12 during the second obtained TXOP and the second SP then ends.

In some embodiments, a first STA may include one or more parameters in the QoS request describing the QoS requirement for the second STA's P2P needs when the first STA transmits a QoS request to its associated AP on behalf of a second STA for the second STA's P2P transmission over a P2P direct link. The QoS request sent by the first STA may also comprise an identifier that identifies the second STA.

In some embodiments, the parameters of the QoS request may include various information, for example and without limitation, including a user identifier, a traffic identifier, a user priority, a link ID, a direction and stream identification.

The user identifier provides identification for a user (e.g., STA or AP) for which the SCS request for P2P transmission is made. In an embodiment, for example and without limitation, an association ID 12 (AID12) may identify the user for which the resource for P2P direct link is requested. More particularly, the AID12 may identify the user whose AID is equal to the value in the AID12 subfield. In some embodiments, the term users and user refer to STAs and STA respectively.

Traffic identifier (TID) provides identification for the P2P traffic for which the QoS request is made for the P2P direct link.

User Priority indicates the user priority of the P2P traffic for which the QoS request is made for the P2P direct link. In some embodiments, the term users refers to STAs.

Link ID indicates the link in a multi-link operation context over which the resource from the AP is requested for P2P transmission. In one embodiment, for example and without limitation, the Link ID may indicate the link with which the requesting STA expects to receive the trigger frame from the AP for transmitting P2P traffic over a P2P direct link operating on that AP's link.

Direction indicates the direction of the traffic indicated in the QoS request. In one embodiment, for example, but not limited to, “Direct Link” may be indicated by the value 0 and “Uplink” or “Downlink” may be indicated by other values.

Stream identification identifies the P2P traffic stream corresponding to the QoS request. In one embodiment, for example, but not limited to, a SCS ID may be used to identify the P2P traffic stream.

In some embodiments, a first STA transmits a SCS request frame to an associated AP to request QoS for a P2P direct link on behalf of a second STA. The SCS request frame comprises a request to establish two P2P QoS streams with the AP. The first stream is for the first STA. The second stream is for the second STA. Accordingly, the SCS Request frame may comprise two SCS Descriptor elements in the SCS Descriptor List field of the SCS Request frame. The first SCS Descriptor element is for the first STA's P2P traffic stream. The second SCS Descriptor element is for the second STA's P2P traffic stream. The QoS Characteristics element of the first SCS Descriptor element comprises the QoS Parameters for the first STA's P2P traffic over a P2P direct link. The QoS Characteristics element of the second SCS Descriptor element comprises the QoS Parameters for the second STA's P2P QOS request.

In some embodiments, the second non-AP STA may also be associated with the AP.

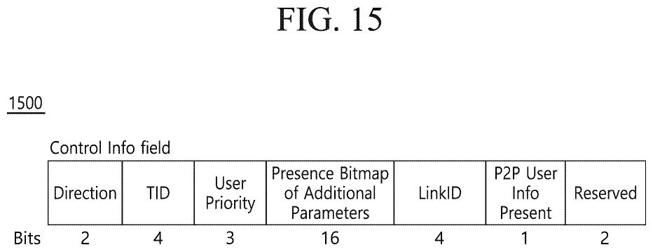

FIG. 15 shows an example of a Control Info field of the QoS Characteristics element in accordance with an embodiment. FIG. 15 is for exemplary purposes only and shall not constitute any limitation on this disclosure.

Referring to FIG. 15, the Control Info field 1500 includes a Direction subfield, a TID subfield, a User Priority subfield, a Presence Bitmap of Additional Parameters subfield, a Link ID subfield, a P2P User Info Present subfield, and Reserved Bits. The Direction subfield indicates the direction of data, such as uplink, downlink, or direct link. The direct link indicates that frames, more specifically medium access control (MAC) service data units (MSDUs) or aggregate (A)-MSDUs, are sent over a P2P link to a peer STA. The traffic ID (TID) subfield indicates a TID value of data frame described by the QoS characteristic element 1600. The User Priority subfield indicates the user priority value (0-7) of the data frames described by the QoS characteristic element 1600. The Presence Bitmap Of Additional Parameters subfield indicates a bitmap where the i-th entry of the bitmap is set to 1 if the i-th field starting from the Maximum MSDU Size field is present in QoS characteristic element 1600. The Link ID subfield contains the link identifier that corresponds to the link for which the direct link transmissions are going to occur. The P2P User Info Present subfield may indicate whether P2P User Information is present in the QoS Characteristics element, for example when P2P User Info Present is set to 1.

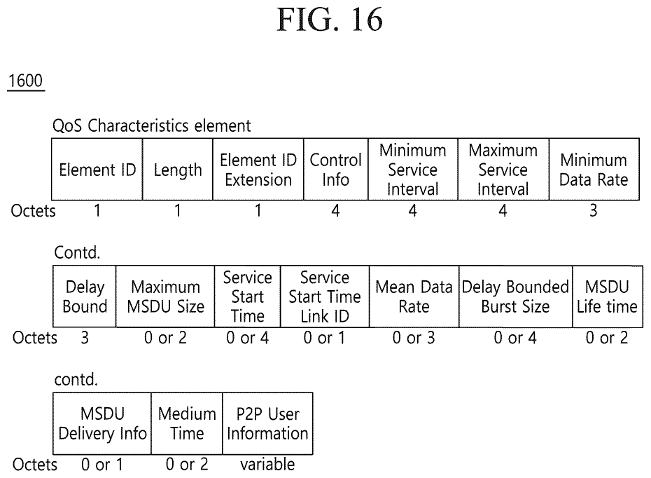

FIG. 16 shows an example of a QoS Characteristics element in accordance with an embodiment. FIG. 16 is for exemplary purposes only and shall not constitute any limitation on this disclosure.

Referring to FIG. 16, the QoS characteristic element 1600 includes an Element ID field, a Length field, an Element ID Extension field, a control field, a Minimum Service Interval field, a Maximum Service Interval field, a Minimum Date Rate field, a Delay Bound field, a Maximum MSDU Size field, a Service Start Time field, a Service Start Time Link ID field, a Mean Data Rate field, a Delay Bounded Burst Size field, a MSDU Lifetime field, a MSDU Delivery Info field, Medium Time field and a P2P User Information field.

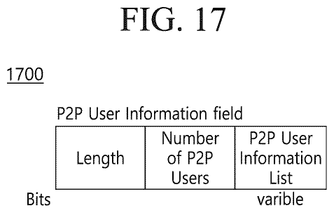

The Element ID field provides an identifier for the QoS Characteristics element. The Length field provides the length of the QoS Characteristics element. The Element ID Extension field provides an extension for the Element ID field of the QoS Characteristics element. The Control Info field provides information comprising FIG. 15. The Minimum Service Interval field may indicate the minimum interval between the start of two consecutive service periods that are allocated for frame exchanges. The Maximum Service Interval field may indicate the maximum interval between the start of two consecutive periods that are allocated for frame exchanges. The Minimum Data Rate field may indicate the lowest data rate for transport of frames belonging to a traffic flow described by this element. The Delay Bound field may indicate the maximum amount of time targeted to transport a frame belonging to a traffic flow described by this element. The Maximum MSDU Size field may indicate the maximum size of the medium access control (MAC) service data unit (MSDU) belonging to a traffic flow described by this element. The Service Start Time field may indicate the time at which the SP began. The Service Start Time Link ID field may indicate the anticipated time when the traffic starts for the associated traffic ID (TID) described in this element. The Mean Data Rate field may indicate the maximum burst of the data units belonging to the traffic that arrives from the MAC. The MSDU Lifetime field may indicate the maximum amount of time since arrival of the data unit at the MAC data service interface beyond which the data unit is not useful. The MSDU Delivery Info field may indicate a MSDU Delivery Ratio subfield and a MSDU Count Exponent subfield. The Medium Time field may indicate the medium time requested by a STA as the average medium time needed in each second. The P2P User Information field may include information as shown in FIG. 17.

The P2P User Information subfield shall be present in the QoS Characteristics element 1600 if the P2P User Info Present subfield is set to 1. If the P2P User Info Present subfield is not set to 1 then the P2P User Information subfield shall not be present in the QoS Characteristics element.

FIG. 17 shows an example of the P2P User Information field in the QoS Characteristics element. FIG. 17 is for exemplary purposes only and shall not constitute any limitation on this disclosure.

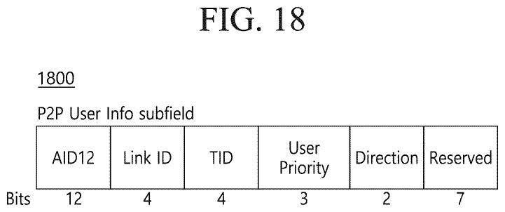

In FIG. 17, the P2P User Information field 1700 includes a Length subfield, a Number of P2P Users subfield and P2P User Information List. The Length subfield may indicate a length of the User Information field. The Number of P2P Users subfield may indicate the number of users for which the QoS information is provided by the QoS Characteristics element. The P2P User Information List subfield may include P2P user information and may be described as in FIG. 18.

FIG. 18 shows an example of the P2P User Info subfield. FIG. 18 is for exemplary purposes only and shall not constitute any limitation on this disclosure.

In FIG. 18, the P2P User Information List 1800 includes an AID12 subfield, a Link ID subfield, a TID subfield, a User priority subfield, a Direction subfield and Reserved bits. The association ID 12 (AID12) subfield may indicate a 12 bit association identifier information. The Link ID subfield may indicate a link identifier information. The traffic ID (TID) subfield may indicate a traffic identifier. The User Priority subfield may indicate a user priority information. The Direction subfield may indicate a direction information, including a direct link, up-link or down-link.

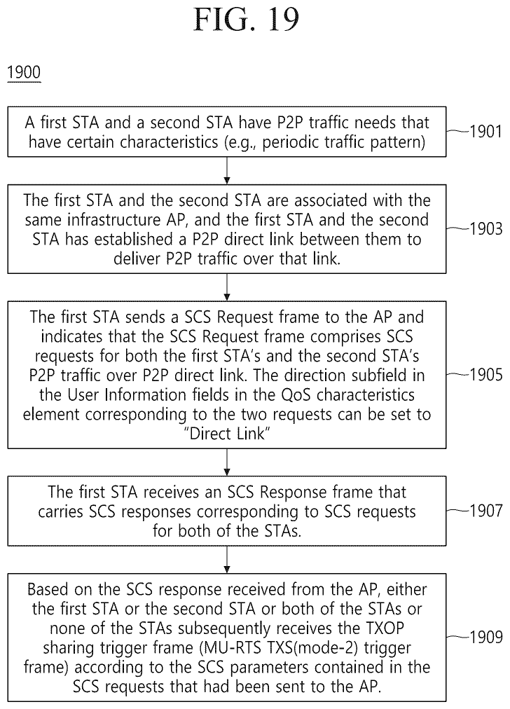

FIG. 19 shows an example process 1900 in accordance with an embodiment. Although one or more operations are described or shown in particular sequential order, in other embodiments the operations may be rearranged in a different order, which may include performance of multiple operations in at least partially overlapping time periods. The process 1900 may be performed in a STA.

In FIG. 19, a STA-side procedure for a first STA requesting P2P QOS negotiation on behalf of a second STA is depicted. FIG. 19 is exemplary and shall not be deemed to constitute a limitation on this disclosure.

The process 1900 may begin in operation 1901. In operation 1901, a first STA and a second STA have P2P traffic that needs certain characteristics, such as periodic traffic pattern.

In operation 1903, the first STA and the second STA are associated with the same infrastructure AP, and the first STA and the second STA have established a P2P direct link between them to deliver P2P traffic over that link.

In operation 1905, the first STA transmits a SCS Request frame to the AP. The SCS Request frame indicates that the SCS Request frame comprises SCS requests for both the first STA's and the second STA's P2P traffic over P2P direct link. The direction subfield in the User Information fields in the QoS characteristics element corresponding to the two requests may be set to “Direct Link”.

In operation 1907, the first STA receives an SCS Response frame that carries SCS responses corresponding to SCS requests for both STAs.

In operation 1909, one of the first STA, the second STA, both the first STA and the second STA or none of the STAs receives the TXOP sharing trigger frame based on the SCS response received. The determination of which STA or how many STAs receive the TXOP sharing trigger frame is determined according to the SCS parameters comprised in the SCS requests that the first STA transmitted to the infrastructure AP.

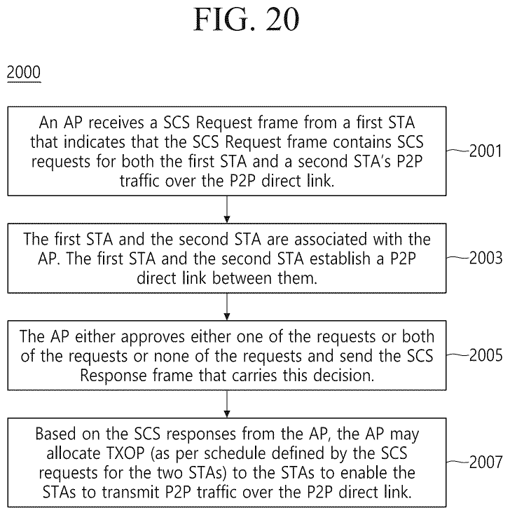

FIG. 20 shows an example process 2000 in accordance with an embodiment. Although one or more operations are described or shown in particular sequential order, in other embodiments the operations may be rearranged in a different order, which may include performance of multiple operations in at least partially overlapping time periods. The process 2000 may be performed in an AP.

In FIG. 20, an AP-side procedure for an AP responding to SCS negotiation on behalf of another STA. FIG. 20 is exemplary and shall not be deemed to constitute a limitation on this disclosure.

The process 2000 may begin in operation 2001. In operation 2001, an AP receives a SCS Request frame from the first STA. The SCS request frame indicates that the SCS Request frame comprises SCS requests for both the first STA and a second STA's P2P traffic over the P2P direct link.

In operation 2003, the first STA and the second STA are associated with the AP. The first STA and the second STA establish a P2P direct link between them.

In operation 2005, the AP either approves either one of the requests or both of the requests or none of the requests and transmits the SCS Response frame with the determination.

In operation 2007, based on the SCS responses from the AP, the AP may allocate TXOP (transmission opportunity) to the STAs to enable the STAs to transmit P2P traffic over the P2P direct link as per schedule defined by the SCS requests for the two STAs.

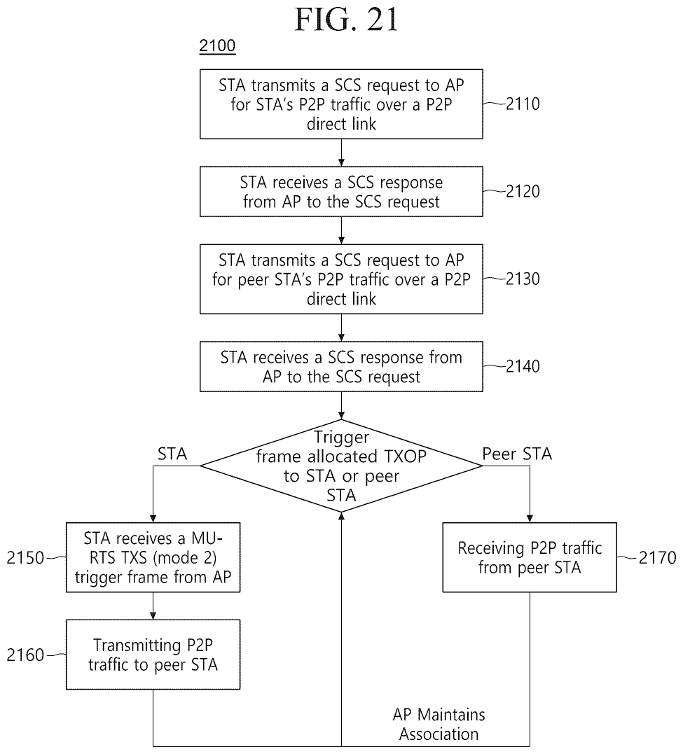

FIG. 21 shows a flowchart of the operations of a STA in accordance with an embodiment of this invention. Although one or more operations are described or shown in particular sequential order, in other embodiments the operations may be rearranged in a different order, which may include performance of multiple operations in at least partially overlapping time periods.

In FIG. 21, there is a STA 111, a peer STA 111 and an AP 101. FIG. 21 is exemplary and shall not be deemed to constitute a limitation on this disclosure.

The process 2100 may begin in operation 2110. In operation 2110, STA 111 transmits a first SCS request to AP 101 by the RF transceiver 210 for STA 111's P2P traffic over a P2P direct link.

In operation 2120, STA 111 receives a SCS response with the RF transceiver 210 from the AP 101 in response to the first SCS request.

In operation 2130, STA 111 then may transmit a second SCS request to AP 101 by the RF transceiver 210 for peer STA 111's P2P traffic over a P2P direct link.

In operation 2140, STA 111 receives a SCS response with the RF transceiver 210 from the AP 101 in response to the second SCS request.

In some embodiments, STA 111 transmits a joint SCS request by the RF transceiver 210 to AP 101 for the P2P traffic of STA 111 and peer STA 111. STA 111 then may receive a joint SCS response with the RF transceiver 210 from AP 101 in response to the joint SCS request.

In operation 2150, STA 111 receives a trigger frame with the RF transceiver 210 from AP 101 if AP 101 determined in the first SCS response to allocate TXOP to STA 111.

In operation 2160, STA 111 transmits P2P traffic by the RF transceiver 210 to peer STA 111 during the duration of a SP determined by the AP 101.

In operation 2170, STA 111 receives P2P traffic with the RF transceiver 210 from peer STA 111 during the SP of the TXOP granted to peer STA 111, if AP 101 transmitted a MU-RTS TXS (mode 2) trigger frame to peer STA 111.

STA 111 shall receive transmissions according to 2150 and 2170, for as long as AP 101 maintains association with STA 111 or peer STA 111.

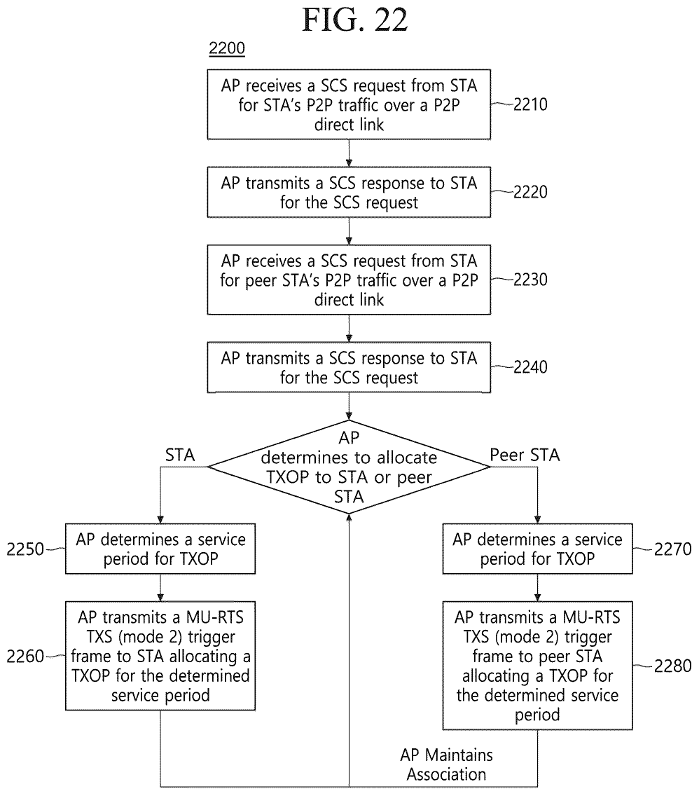

FIG. 22 shows a flowchart of the operations of an AP in accordance with an embodiment of this invention. Although one or more operations are described or shown in particular sequential order, in other embodiments the operations may be rearranged in a different order, which may include performance of multiple operations in at least partially overlapping time periods.

In FIG. 22, there is an AP 101, a STA 111 and a peer STA 111. FIG. 22 is exemplary and shall not be deemed to constitute a limitation on this disclosure.

The process 2200 may begin in operation 2210. In operation 2210, AP 101 receives a first SCS request from a STA 111 with a RF transceiver 209 for STA 111's P2P traffic over a P2P direct link.

In operation 2220, AP 101 transmits a first SCS response to STA 111 by a RF transceiver 209 in response to the first SCS request.

In operation 2230, AP 101 receives a second SCS request from STA 111 with a RF transceiver 209 for a peer STA 111's P2P traffic over a P2P direct link.

In operation 2240, AP 101 transmits a second SCS response to STA 111 by a RF transceiver 209 in response to the second SCS request.

In some embodiments, AP 101 receives a joint SCS request by the RF transceiver 209 from STA 111 for the P2P traffic of STA 111 and peer STA 111. AP 101 then transmits a joint SCS response with the RF transceiver 209 to STA 111 and/or peer STA 111 in response to the joint SCS request.

In operation 2250, AP 101 determines a SP for a TXOP for STA 111 if, in the first SCS response, AP 101 determined to accept STA 111's first SCS request and determined to allocate won TXOP to STA 111.

In operation 2260, AP 101 transmits a trigger frame by a RF transceiver 209 to STA 111 allocating a TXOP to STA 111 for the SP determined in operation 2250.

In operation 2270, AP 101 determines a SP for a TXOP for peer STA 111 if, in the second SCS response, AP 101 determined to accept STA 111's second SCS request and determined to allocate won TXOP to peer STA 111.

In operation 2280, AP 101 transmits a trigger frame by RF transceiver 209 to peer STA 111 allocating a TXOP to peer STA 111 for the SP determined in operation 2270.

Subsequent to operation 2260 or 2280, AP 101 shall make TXOP allocation determinations, determine service periods and transmit trigger frames according to operations 2250-2260 and operations 2270-2280 of this flowchart, for as long as AP 101 maintains an association with STA 111 or peer STA 111.

According to various embodiments, a first STA requests, from an AP, a resource on behalf of a second STA so that AP will be able to efficiently allocate time (or TXOP) of the pending traffic from the first STA to the second or from the second STA to the first STA in their P2P communication, so that latency sensitive traffic may be delivered in a timely manner.

The various illustrative blocks, units, modules, components, methods, operations, instructions, items, and algorithms may be implemented or performed with processing circuitry.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the subject technology. The term “exemplary” is used to mean serving as an example or illustration. To the extent that the term “include,” “have,” “carry,” “contain,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, the description may provide illustrative examples and the various features may be grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The embodiments are provided solely as examples for understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of this invention.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A first station (STA) in a wireless network, comprising:
a memory; and
a processor coupled to the memory, the processor configured to cause:
transmitting, to an access point (AP), a request frame that requests a resource from the AP for a peer-to-peer (P2P) transmission performed by a second STA, wherein a P2P link is established between the first STA and the second STA.

2. The first STA of claim 1, wherein the request frame includes Quality of Service (QOS) requirement for the second STA.

3. The first STA of claim 1, wherein the request frame further requests a resource from the AP for a P2P transmission performed by the first STA.

4. The first STA of claim 3, wherein the request frame requests a resource from the AP for P2P transmissions performed by a plurality of STAs.

5. The first STA of claim 3, wherein the request frame includes QOS requirement for the first STA.

6. The first STA of claim 3, wherein the request frame further comprises a first element associated with QoS requirement for the first STA and a second element associated with QoS requirement for the second STA.

7. The first STA of claim 3, wherein the processor is further configured to cause:
receiving, from the AP, a trigger frame that allocates a transmission opportunity (TXOP); and
performing a P2P communication with a peer STA during the allocated TXOP.

8. The first STA of claim 7, wherein:
the trigger frame is received during a target wake time (TWT) service period (SP) established between the first STA and the AP; and
the processor is configured to cause performing the P2P communication with the peer STA during the TWT SP.

9. An access port (AP) in a wireless network, comprising:
a memory; and
a processor coupled to the memory, the processor configured to cause:
receiving, from a first station (STA), a request frame that requests a resource from the AP for a peer-to-peer (P2P) transmission performed by a second STA, wherein a P2P link is established between the first STA and the second STA; and
transmitting, to the second STA, a first trigger frame that allocates a transmission opportunity (TXOP) to the second STA in response to the request frame.

10. The AP of claim 9, wherein the request frame includes Quality of Service (QOS) requirement for the second STA.

11. The AP of claim 9, wherein the request frame further requests a resource from the AP for a P2P transmission performed by the first STA.

12. The AP of claim 10, wherein the request frame requests a resource from the AP for P2P transmissions performed by a plurality of STAs.

13. The AP of claim 11, wherein the request frame includes QoS requirement for the first STA.

14. The AP of claim 11, wherein the request frame further comprises a first element associated with QoS requirement for the first STA and a second element associated with QoS requirement for the second STA.

15. The AP of claim 11, wherein the processor is further configured to cause:
transmitting, to the first STA, a second trigger frame that allocates a transmission opportunity (TXOP) in response to the request frame.

16. The AP of claim 10, wherein
the first trigger frame is transmitted to the second STA during a first target wake time (TWT) service period (SP); and
the second trigger frame is transmitted to the first STA during a second TWT SP.

17. A method performed by a station (STA) in a wireless network, comprising:
transmitting, to an access point (AP), a request frame that requests a resource from the AP for a peer-to-peer (P2P) transmission performed by a second STA, wherein a P2P link is established between the first STA and the second STA.

18. The method of claim 17, wherein the request frame includes Quality of Service (QOS) requirement for the second STA.

19. The method of claim 16, further comprising:
receiving, from the AP, a trigger frame that allocates a transmission opportunity (TXOP); and,
performing a P2P communication with a peer STA during the allocated TXOP.

20. The method of claim 19, wherein the trigger frame is received during a target wake time (TWT) service period established between the first STA and the AP; and
performing the P2P communication with the peer STA during the TWT SP.
